(19) United States
(12) Patent Application Publication
(10) Pub. No.: US 2015/0015098 A1
(43) Pub. Date: Jan. 15, 2015

(54) ROTOR WITH COOLING PASSAGE AND MOTOR HAVING THE SAME

(71) Applicant: FANUC CORPORATION, Yamanashi (JP)

(72) Inventor: Koutarou Suzuki, Yamanashi (JP)

(21) Appl. No.: 14/327,620

(22) Filed: Jul. 10, 2014

(30) Foreign Application Priority Data
Jul. 12, 2013 (JP) 2013-146914

(51) Int. Cl. H02K 1/32

(52) U.S. Cl. CPC H02K 1/32
USPC 310/59

(57) ABSTRACT

In a rotor of a motor according to the present invention, a plurality of flow passages spaced apart from each other around an axis of rotation, each of which extends so as to be slanted relative to an axis of rotation and open to an exterior space of the rotor at both ends of the rotor. The flow passages are configured so that adjacent flow passages are slanted alternately in opposite directions and that a fluid for cooling the rotor circulates through the flow passages.

### BACKGROUND OF THE INVENTION

1. Field of the Invention

The present invention relates to a rotor and a motor having a rotor.

2. Description of the Related Art

In a rotor of a motor, it is known to provide a cooling structure having a plurality of through-holes formed so as to extend through the rotor along an axial direction thereof and designed to cool the rotor by causing ambient air to flow through the through-holes.

For example, JP-A-2004-312898 discloses a structure for cooling a rotor and a stator by forming an axial hole passing through the rotor along an axial direction thereof and a radial hole extending between the axial hole and the outer circumferential surface of the rotor in a radial direction. JP-U-6-48355 discloses a structure for cooling a rotor by forming a through-hole in the rotor extending at an angle relative to the axis of the rotor.

However, in the cooling structure disclosed in JP-A-2004-312898, as the rotational speed of the rotor increases, the resistance to air flow passing through the axial hole increases, and as a result, the amount of air passing through the passage inside the rotor decreases. Therefore, a sufficient cooling effect cannot be obtained during high-speed operation where the amount of heat generation increases. In the cooling structure disclosed in JP-U-6-48355, an air stream passing through the slanted through-hole is generated with the aid of centrifugal force. However, since the air inlet and outlet are located at opposite ends of the rotor, air must be forcefully circulated using a circulating means, such as a fan, in order to prevent the pressure near the inlet from decreasing. This leads to complicated structure and increased cost.

Therefore, there is a need for a rotor having an improved cooling effect.

### SUMMARY OF THE INVENTION

According to a first aspect of the present invention, a rotor of a motor rotatable about an axis of rotation, the rotor being provided with a plurality of flow passages spaced apart from each other around the axis of rotation, each of which extends so as to be slanted relative to the axis of rotation and open to an exterior space of the rotor at opposite ends thereof, wherein the plurality of flow are configured so that adjacent flow passages are slanted alternately in opposite directions and that a fluid for cooling the rotor circulates through the plurality of flow passages, is provided.

According to a second aspect of the present invention, in the rotor according to the first aspect, the plurality of flow passages are equally spaced apart from each other around the axis of rotation.

According to a third aspect of the present invention, a motor comprising the rotor according to the first or second aspect is provided.

According to a fourth aspect of the present invention the motor according to the third aspect further comprises a cooling unit in the vicinity of at least one end of the rotor.

These and other objects, features and advantages of the present invention will become more apparent in light of the detailed description of exemplary embodiments thereof as illustrated by the drawings.

### BRIEF DESCRIPTION OF THE DRAWINGS

FIG. 1 is a half sectional view showing the configuration of a motor according to one embodiment of the present invention.

FIG. 2 is an end view showing a rotor according to one embodiment of the present invention.

FIG. 3 is a sectional view taken along line III-III in FIG. 2.

FIG. 4 is a sectional view taken along line IV-IV in FIG. 2.

### DETAILED DESCRIPTION OF THE INVENTION

An embodiment of the present invention will be described below with reference to the accompanying drawings. Constituent elements of the illustrated embodiment may be modified in size in relation to one another for better understanding of the present invention.

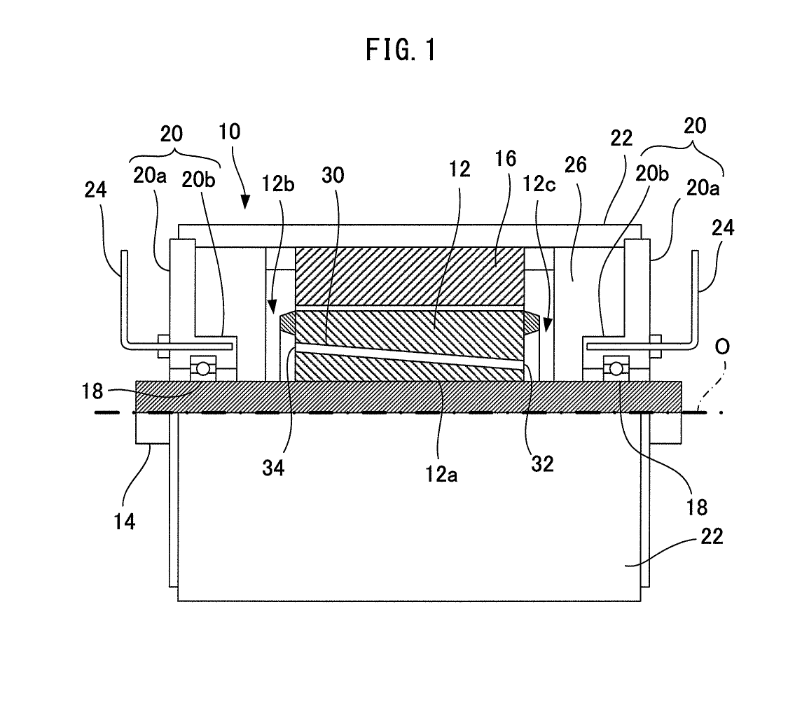

FIG. 1 is a half sectional view showing the configuration of a motor 10 according to one embodiment of the present invention. The motor 10 includes a rotational axis 14 rotatable about an axis of rotation O, a rotor 12 fitted to an outer circumferential surface of the rotational axis 14 designed to provide the rotational axis 14 with rotational power, and a stator 16 spaced apart from the rotor 12 radially outwardly so as to surround the rotor 12. FIG. 1 shows the upper half of the motor 10 in a longitudinal section view and the lower half in a side view. The motor 10 is not limited to the illustrated type, but may have any known configuration. The motor 10 may be a synchronous motor or an induction motor.

The rotor 12 is a substantially cylindrical member formed, for example, by laminating electromagnetic steel sheets. The rotor 12 is provided with an axial hole 12a passing through the center thereof. The rotational axis 14 is fitted to the axial hole 12a of the rotor 12 by an interference fit so as to rotate together with the rotor 12 when the motor 10 is in operation.

The stator 16 is a cylindrical member formed from a magnetic material. The stator 16 is configured to cooperate with the rotor 12 so as to generate driving force for rotating the rotor 12 and the rotational axis 14. In the motor 10, the configuration and mechanism for generating rotational driving force is well known, and therefore the detailed description thereon will be omitted therein.

The rotational axis 14 is a substantially cylindrical member made of metal. The rotational axis 14 is supported rotatably about the axis of rotation O by means of bearings 18 mounted on the inner circumferential surfaces of annular flange members 20. The flange members 20 and the bearings 18 are provided at opposite ends of the rotational axis 14. Each flange member 20 has a substantially L-shaped in longitudinal section view, and includes a first portion 20a extending radially outwardly from the outer circumference of the rotational axis 14 and a second portion 20b extending axially from one end of the first portion 20a.

The first portion 20a of each flange member 20 is attached to a housing 22 of the motor 10. At least one cooling pipe 24 extending into the interior of the second portion 20b is mounted in each flange member 20. A coolant, such as cooling oil, is supplied to the cooling pipes 24 so that the coolant is circulated through the interiors of the flange members 20.

Each bearing 18 has a bearing housing for accommodating the bearing 18 therein. The bearing housings, together with the flange members 20 and the housing 22 of the motor 10, defines an interior space 26 which accommodates the stator 16 and the rotor 12. Accordingly, the flange members 20 cooled by the coolant flowing through the cooling pipe 24 serves as a cooling member for cooling the interior space 26 of the motor 10.

In the present embodiment, the rotor 12 is formed with cooling passages 30, each of which extends through the rotor 12 from a first end 12b to a second end 12c of the rotor 12. Therefore, each cooling passage 30 is open to the interior space 26 at the first and second ends 12b and 12c, respectively. Further, each cooling passage 30 is formed so as to be slanted with respect to the axis of rotation O, so that air flows through the cooling passage 30 from an inlet 32 to an outlet 34 with the aid of centrifugal force generated when the rotor 12 is rotating. As further described below, the cooling passages 30 are configured such that the adjacent cooling passages 30 are slanted alternately in opposite directions.

Each cooling passage 30 is formed by perforating the rotor 12 along the axis of rotation O, for example, by drilling. In the case where the rotor 12 has a laminated structure formed by laminating steel sheets, the steel sheets may be formed with holes by punching with a press machine, and the cooling passage 30 may be formed by the holes combined with one another.

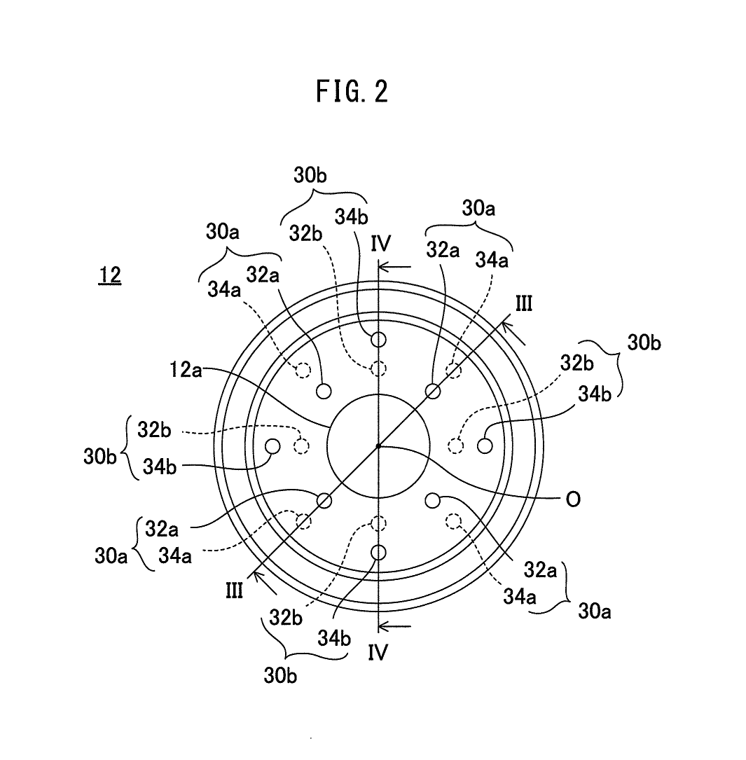

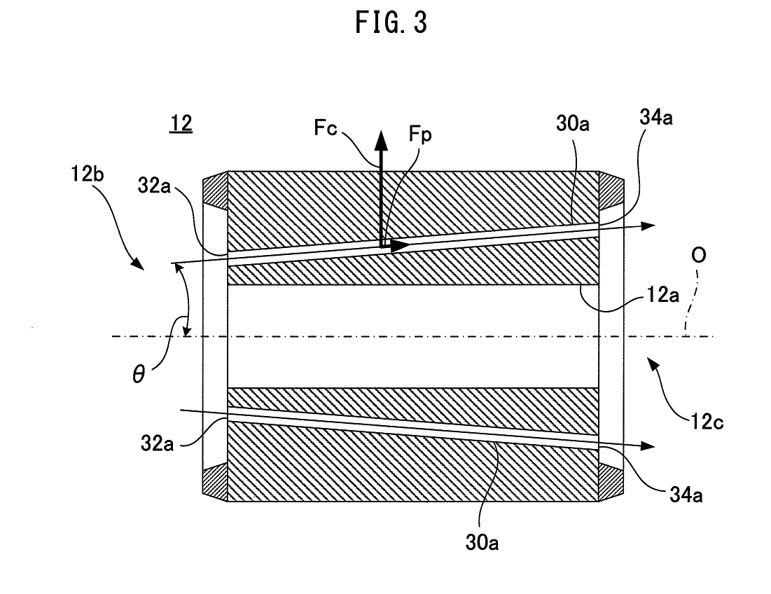

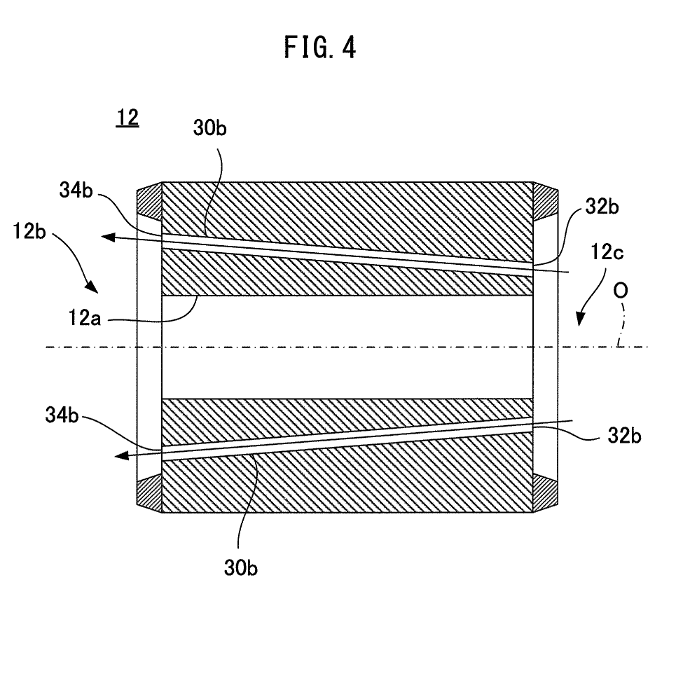

Next, referring to FIGS. 2 to 4, the configuration of the cooling passages 30 according to the present embodiment and the cooling effect achieved by them will be described in further detail. FIG. 2 is an end view showing the rotor 12 according to one embodiment of the present invention. FIG. 3 is a sectional view taken along line in FIG. 2. FIG. 4 is a sectional view taken along line IV-IV in FIG. 2.

In the present embodiment, the cooling passages 30 are formed by first cooling passages 30a, each of which has an inlet 32a on the side of the first end 12b of the rotor 12, and by second cooling passages 30b, each of which has an inlet 32b on the side of the second end 12c of the rotor 12. Each first cooling passage 30a has an outlet 34a on the side of the second end 12c of the rotor 12. On the other hand, each second cooling passage 30b has an outlet 34b on the side of the first end 12b of the rotor 12. As shown in FIG. 2, the first and second cooling passages 30a and 30b are arranged alternately around the axis of rotation O. In FIG. 2 which shows an end view of the rotor 12 seen from the side of the first end 12b, the outlets 34a of the first cooling passages 30a and the inlets 32b of the second cooling passages 30b are indicated by dashed lines, although they are formed at the second end 12c and therefore cannot actually be seen in the end view.

Although not necessarily, it is preferable that the same number of the first cooling passages 30a are formed as the second cooling passages 30b and that they are equally spaced apart from each other around the axis of rotation 0. This allows the rotor 12 to maintain the structural balance.

As shown in FIG. 3, the centrifugal force Fc generated when the rotor 12 is rotating has a flowing direction component Fp (=Fc·sinθ (where θ is an angle formed between the first cooling passage 30a and the axis of rotation O)) that acts in a direction parallel to the first cooling passage 30a. By the virtue of this flowing direction component Fp, air around the rotor 12 is caused to flow in the direction shown by arrows in FIG. 3, or in other words, from the inlet 32a on the side of the first end 12b to the outlet 34a on the side of the second end 12c. Although the first cooling passages 30a have been explained by way of example, an air stream is generated in the second cooling passage 30b in a similar manner, specifically, from the inlet 32b on the side of the second end 12c of the rotor 12 which is located on the inner side in the radial direction, toward the outlet 34b at the first end 12b on the opposite side, with the aid of the centrifugal force Fc.

According to the present embodiment, the first and second cooling passages 30a and 30b are arranged alternately in the circumferential direction of the rotor 12. In other words, the outlet 34a of the first cooling passage 30a and the inlet 32b of the second cooling passage 30b are arranged adjacent to each other in the circumferential direction. Similarly, the outlet 34b of the second cooling passage 30b and the inlet 32a of the first cooling passage 30a are arranged adjacent to each other in the circumferential direction (see FIG. 2). According to this arrangement, air heated to a relatively high temperature as a result of heat exchange with the rotor 12 as it travels through the first cooling passage 30a or the second cooling passage 30a is coexistent with air at a relatively low temperature, which is about to enter the first cooling passage 30a or the second cooling passage 30b at the first and second ends 12b and 12c of the rotor 12. Therefore, there is no considerable temperature difference between the first end 12b, the second end 12c, and the interior of the rotor 12, and the rotor 12 is uniformly cooled on the whole. In addition, since air flowing out of one of the first and second cooling passages 30a and 30b prevents the pressure near the inlet of the other of the cooling passages from decreasing, an air stream can be smoothly circulated. According to the present embodiment, the air stream flowing through the first and second cooling passages 30a and 30b can be circulated more effectively, without an additional component such as a fan for forcefully circulating the air. As a result, the rotor 12 can be cooled efficiently.

Furthermore, by the virtue of the cooling members arranged at the first and second ends 12b and 12c of the rotor 12, such as the flange members 20 described with reference to FIG. 1, which are designed to forcefully cool the ambient temperature, the air stream circulating through the first and second cooling passages 30a and 30b can be cooled. Thus, the cooling effect for the rotor 12 can be enhanced even further. The cooling member may be provided only at one of the first and second ends 12b and 12c of the rotor 12.

### Effect of the Invention

According to the rotor having the above-described configuration, a plurality of flow passages are formed so as to be slanted alternately in opposite directions with respect to the axis of rotation. As a result, the cooling fluid at a relatively low temperature near the inlet and the cooling fluid heated to a relatively high temperature near the outlet are coexistent close to each other, which balances out the temperature gradient within the rotor, and the entire structure of the rotor can be uniformly cooled. Furthermore, since no pressure decline occurs at either end face of the rotor, the circulation of the cooling fluid is facilitated. With these features, the cooling efficiency of the rotor as a whole can be enhanced.

The motor having the above-described configuration can also enjoy the above advantages of the rotor.

By the virtue of the cooling member provided in the vicinity of least one of the ends of the rotor, fluid flowing out of the flow passage at a relatively high temperature can be cooled, thereby further enhancing the cooling effect.

Although various embodiments and modifications of the present invention have been described, it is obvious for those skilled in the art that other embodiments and modifications can also realize the intended effects and advantages of the invention. In particular, it is possible to omit or replace the constituent elements of the embodiments and modifications described herein, or add a known means thereto, without departing from the scope of the invention. It is also obvious for those skilled in the art that the invention can be implemented by any combination of the features of the embodiments explicitly or implicitly disclosed herein.

What is claimed is:

1. A rotor of a motor rotatable about an axis of rotation, the rotor being provided with a plurality of flow passages spaced apart from each other around the axis of rotation, each of which extends so as to be slanted relative to the axis of rotation and open to an exterior space of the rotor at opposite ends thereof,
wherein the plurality of flow are configured so that adjacent flow passages are slanted alternately in opposite directions and that a fluid for cooling the rotor circulates through the plurality of flow passages.

2. The rotor according to claim 1, wherein the plurality of flow passages are equally spaced apart from each other around the axis of rotation.

3. A motor comprising the rotor according to claim 1.

4. The motor according to claim 3, further comprising a cooling unit in the vicinity of at least one end of the rotor.
